(19) United States
(12) Patent Application Publication
(10) Pub. No.: US 2017/0251085 A1
(43) Pub. Date: Aug. 31, 2017

(54) TITANIUM MOBILE PHONE CHASSIS AND METHODS OF MAKING AND USING SAME

(71) Applicant: Essential Products, Inc., Palo Alto, CA (US)

(72) Inventors: Jason Sean Gagne-Keats, Cupertino, CA (US); Andrew E. Rubin, Los Altos, CA (US); David John Evans, V, Palo Alto, CA (US); Matthew Hershenson, Los Altos, CA (US); Xiaoyu Miao, Palo Alto, CA (US); Xinrui Jiang, San Jose, CA (US); Joseph Anthony Tate, San Jose, CA (US)

(21) Appl. No.: 15/157,335

(22) Filed: May 17, 2016

Related U.S. Application Data
(60) Provisional application No. 62/328,435, filed on Apr. 27, 2016.
(60) Provisional application No. 62/300,631, filed on Feb. 26, 2016.

(51) Int. Cl. H04M 1/02; B22F 3/26; B22F 3/22

(52) U.S. Cl. CPC H04M 1/026; B22F 3/225; B22F 3/26; H04M 2201/34; B22F 2003/244

(57) ABSTRACT

The present disclosure relates to titanium or titanium alloy (e.g., titanium/copper alloy) mobile phone chassis, and methods for making and using same.

### CROSS-REFERENCE TO RELATED APPLICATIONS

This application claims the benefit of U.S. Provisional Patent Application No. 62/300,631, entitled “MOBILE DEVICES AND MOBILE DEVICE ACCESSORIES”, filed Feb. 26, 2016, and U.S. Provisional Patent Application No. 62/328,435, entitled “TITANIUM MOBILE PHONE CHASSIS AND METHODS OF MAKING AND USING SAME”, filed Apr. 27, 2016, each of which is incorporated herein in its entirety by this reference thereto.

### TECHNICAL FIELD

The present disclosure relates to custom or titanium alloy (e.g., titanium/copper alloy) mobile phone chassis, and methods for making and using same.

### BACKGROUND

Present day mobile phone devices typically include a chassis consisting primarily of plastic or aluminum. However, these materials are mediocre conductors of heat and therefore can be detrimental to performance and/or life expectancy of the device due to generation of heat by electronic components like processors, displays, GPS, etc.

### SUMMARY

The present disclosure provides mobile phone chassis comprising titanium and copper. In some embodiments, the present disclosure provides a mobile phone chassis consisting essentially of titanium and copper. In other embodiments, the present disclosure provides a mobile phone chassis comprising a metal or metal alloy, wherein the metal or metal alloy consists of titanium and copper.

In some embodiments, the present disclosure provides a method of making a mobile phone chassis, the method comprising providing an injection mold comprising a cavity corresponding to a near-net shape of a mobile phone chassis; injecting a metal injection molding (“MIM”) composition into the injection mold to form a green mobile phone chassis, wherein the MIM composition comprises titanium and at least one binder; debinding the green mobile phone chassis to form a brown mobile phone chassis; and infusing the brown mobile phone chassis with copper to form the mobile phone chassis.

In some embodiments, the present disclosure provides a method of making a mobile phone chassis, the method comprising providing an injection mold comprising a cavity corresponding to a near-net shape of a mobile phone chassis; injecting a MIM composition into the injection mold to form a green mobile phone chassis, wherein the MIM composition comprises titanium, copper, and at least one binder; debinding the green mobile phone chassis to form a brown mobile phone chassis; and sintering the brown mobile phone chassis to form the mobile phone chassis.

The present disclosure also provides mobile phones comprising a mobile phone chassis as disclosed herein.

### BRIEF DESCRIPTION OF THE DRAWINGS

These and other objects, features and characteristics of the present embodiments will become more apparent to those skilled in the art from a study of the following detailed description in conjunction with the appended claims and drawings, all of which form a part of this specification. While the accompanying drawings include illustrations of various embodiments, the drawings are not intended to limit the claimed subject matter.

FIG. 1 shows a process diagram of a method of making a mobile phone chassis according to one embodiment consistent with the present disclosure.

FIG. 2 shows a process diagram of a method of making a mobile phone chassis according to another embodiment consistent with the present disclosure.

### DETAILED DESCRIPTION

### Terminology

Brief definitions of terms, abbreviations, and phrases used throughout this application are given below.

A “mobile phone” refers broadly to a mobile device including one or more communication features, such as telephonic capabilities. The term may also apply in certain embodiments to mobile electronic devices such as music players, tablets, etc., that do not include telephonic communication capabilities.

A “chassis” refers broadly to a housing or enclosure, such as a housing for a mobile phone. As used herein, the term “chassis” does not include a display, but may include elements that accommodate and/or protect a display.

Reference in this specification to “one embodiment” or “an embodiment” means that a particular feature, structure, or characteristic described in connection with the embodiment is included in at least one embodiment in of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

### Overview

A mobile phone chassis includes titanium and optionally copper. Typically, the mobile phone chassis is injection molded, rather than machined or stamped, in order to produce substantially less waste material compared to traditional mobile phone chassis manufacturing methods. The mobile phone chassis provide better thermal conductivity for enabling heat generated by the electronic components of the mobile phone to dissipate, thus enhancing performance and increasing lifespan of the device.

### Mobile Phone Chassis Infused With Copper

In some embodiments, the present disclosure provides mobile phone chassis embodiments produced from titanium MIM compositions. In such embodiments, the MIM composition comprises, consists essentially of, or consists of titanium and at least one binder. In some embodiments, the MIM composition includes substantially no (e.g., less than about 0.1 wt. %, a trace amount, or no measureable amount) copper, but can include >10%.

In some embodiments, the MIM composition or the mobile phone chassis (e.g., after sintering or after post-processing) comprises titanium and about 10 wt. % copper. In other embodiments, the MIM composition or the mobile phone chassis (e.g., after sintering or after post-processing) comprises titanium and at least about 10 wt. % copper, such as about 10 wt. % to about 50 wt. % copper, about 10 wt. % to about 40 wt. % copper, about 10 wt. % to about 30 wt. % copper, about 10 wt. % to about 20 wt. % copper, about 10 wt. % to about 15 wt. % copper, about 10 wt. % to about 14 wt. % copper, about 10 wt. % to about 13 wt. % copper, about 10 wt. % to about 12 wt. % copper, or about 10 wt. % to about 11 wt. % copper.

In some embodiments, the MIM composition or the mobile phone chassis (e.g., after sintering or after post-processing) comprises titanium and about 11 wt. % copper, about 12 wt. % copper, about 13 wt. % copper, about 14 wt. % copper, about 15 wt. % copper, about 16 wt. % copper, about 17 wt. % copper, about 18 wt. % copper, about 19 wt. % copper, about 20 wt. % copper, about 21 wt. % copper, about 22 wt. % copper, about 23 wt. % copper, about 24 wt. % copper, about 25 wt. % copper, about 26 wt. % copper, about 27 wt. % copper, about 28 wt. % copper, about 29 wt. % copper, about 30 wt. % copper, about 31 wt. % copper, about 32 wt. % copper, about 33 wt. % copper, about 34 wt. % copper, about 35 wt. % copper, about 36 wt. % copper, about 37 wt. % copper, about 38 wt. % copper, about 39 wt. % copper, about 40 wt. % copper, about 41 wt. % copper, about 42 wt. % copper, about 43 wt. % copper, about 44 wt. % copper, about 45 wt. % copper, about 46 wt. % copper, about 47 wt. % copper, about 48 wt. % copper, about 49 wt. % copper, or about 50 wt. % copper.

In other embodiments, the MIM composition or the mobile phone chassis (e.g., after sintering or after post-processing) comprises titanium and 0% to about 10% copper.

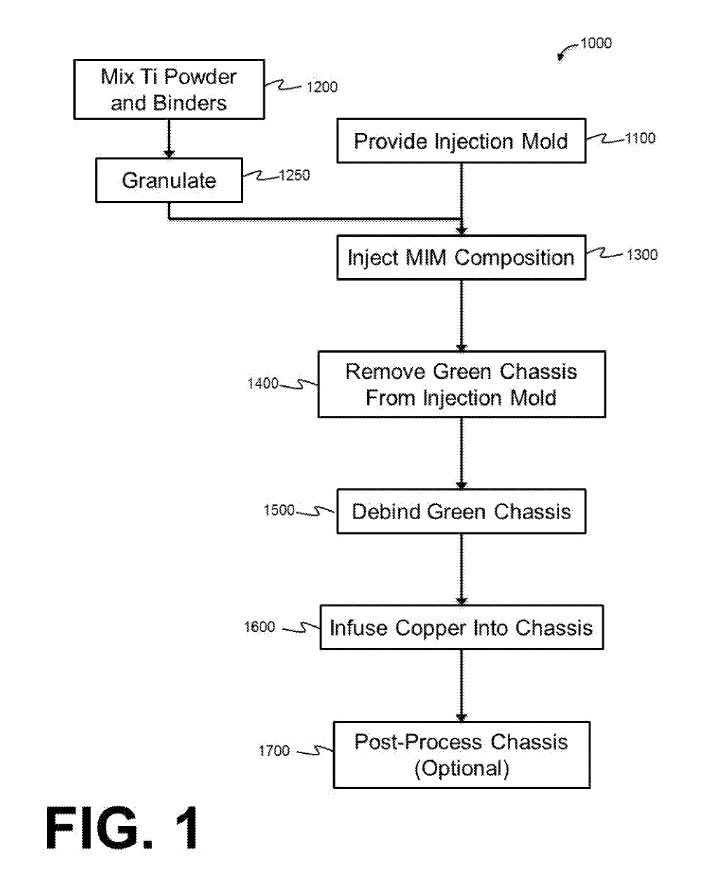

Referring now to FIG. 1, a method 1000 of making a mobile phone chassis comprises injecting the MIM composition 1300 into an injection mold 1100. Any suitable titanium MIM manufacturing system may be used. In some embodiments, the MIM composition is first mixed 1200 and granulated 1250 before injection 1300. Typically, the MIM composition is heated and injected 1300 into the mold 1100 under high pressure.

After the injection 1300 is complete, the molded chassis (referred to as a “green” chassis) is then removed 1400 from the injection mold. After cooling to a suitable temperature, the green chassis is then debound 1500 to remove binder (e.g., a primary binder). Depending on the identity of the binder, debinding 1500 may be accomplished chemically (e.g., by dissolving the binder in a solvent), or thermally (e.g., by heating the green chassis to a suitable temperature to liberate the binder).

The debound chassis (referred to as a “brown” chassis) contains cavities or pores where the binder previously occupied space. These cavities may be infused with copper 1600 to provide additional thermal conductivity to the mobile phone chassis. In some embodiments, the brown chassis is first sintered and then infused with copper 1600. In other embodiments, the brown chassis is first infused with copper 1600 and then optionally sintered to remove any remaining binder (e.g., a secondary binder). In some embodiments, the brown chassis is infused 1600 during a sintering step.

After cooling, the mobile phone chassis comprising titanium and copper may then be post-processed 1700, for example to incorporate an antenna break and/or any other design requirement required to prepare the mobile phone chassis for mating with the electronic components of the mobile phone.

### Mobile Phone Chassis From Titanium/Copper Mixtures

In some embodiments, the present disclosure provides mobile phone chassis embodiments produced from MIM compositions comprising titanium and copper. In such embodiments, the MIM composition comprises, consists essentially of, or consists of titanium, copper, and at least one binder. In some embodiments, the MIM composition includes substantially no (e.g., less than about 0.1 wt. %, a trace amount, or no measurable amount) metal other than titanium and copper.

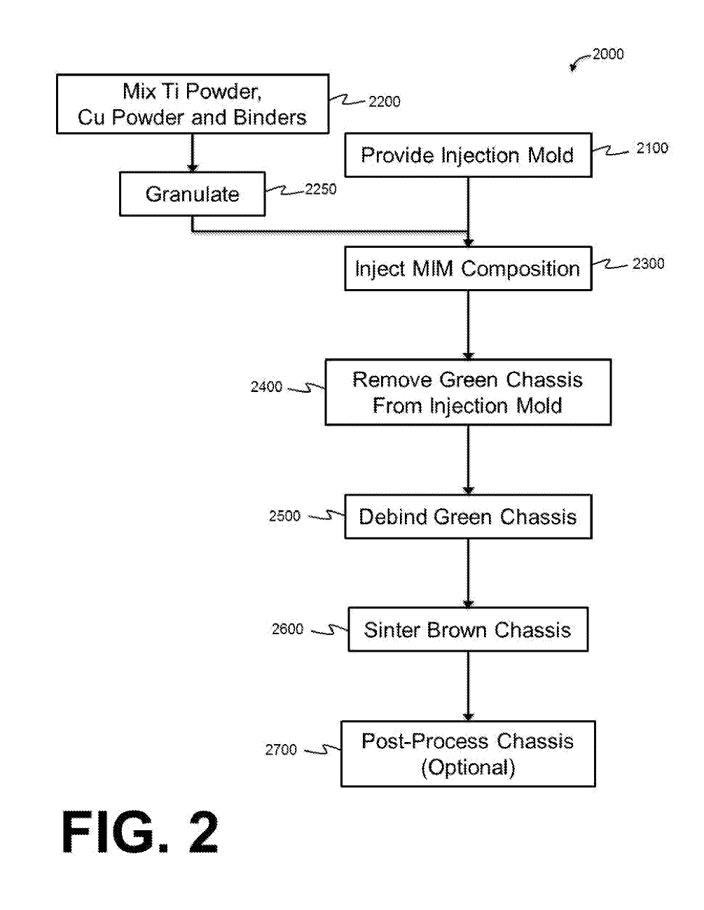

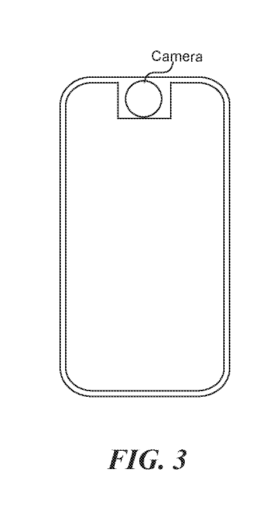

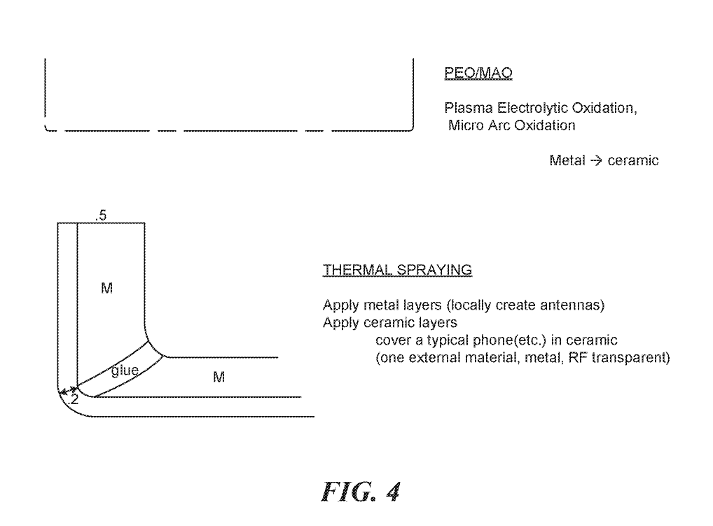

Referring now to FIG. 2, a method 2000 of making a mobile phone chassis comprises injecting the MIM composition 2300 into an injection mold 2100. Any suitable titanium MIM manufacturing system may be used. In some embodiments, the MIM composition is first mixed 2200 and granulated 2250 before injection 2300. Typically, the MIM composition is heated and injected 2300 into the mold 2100 under high pressure.

After the injection 2300 is complete, the molded chassis (referred to as a “green” chassis) is then removed 2400 from the injection mold. After cooling to a suitable temperature, the green chassis is then debound 2500 to remove binder (e.g., a primary binder). Depending on the identity of the binder, debinding 2500 may be accomplished chemically (e.g., by dissolving the binder in a solvent), or thermally (e.g., by heating the green chassis to a suitable temperature to liberate the binder).

The debound chassis (referred to as a “brown” chassis) contains cavities or pores where the binder previously occupied space. These cavities may be collapsed in a sintering step 2600 to form the final mobile phone chassis. Alternatively, the cavities in the brown chassis may be infused with additional copper to provide additional thermal conductivity to the mobile phone chassis.

After cooling, the mobile phone chassis comprising titanium and copper may then be post-processed 2700, for example to incorporate an antenna break and/or any other design requirement required to prepare the mobile phone chassis for mating with the electronic components of the mobile phone.

Performance of Mobile Phones with Titanium/Copper Chassis

In some embodiments, the present disclosure provides a mobile phone comprising a titanium/copper mobile phone chassis. Due to the thermal properties of chassis disclosed herein, the electronic circuitry of the mobile phone may not include a heat sink (e.g., a metallic film).

In some embodiments, a mobile phone comprising a chassis as disclosed herein may be programmed not to underclock if the processor exceeds a specified threshold, such as about 60° C. or about 70° C. Currently available mobile phone devices (e.g., without a titanium-copper chassis) typically include processors programmed to underclock when they reach a certain temperature threshold (e.g., 60° C. or 70° C.). Underclocking reduces the power requirements of the processor, which in turn generates less heat. The processor may be programmed to return to normal power consumption after cooling to a sufficiently low temperature.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following examples.

### Examples

1. A mobile phone chassis comprising titanium and copper.
2. A mobile phone chassis consisting essentially of titanium and copper.
3. A mobile phone chassis comprising a metal or metal alloy, wherein the metal or metal alloy consists of titanium and copper.
4. The mobile phone chassis of any one of examples 1-3, wherein the mobile phone chassis conducts heat substantially greater than a comparable mobile phone chassis including substantially no titanium and/or copper.
5. The mobile phone chassis of any one of examples 1-4 further comprising an antenna break.
6. A method of making a mobile phone chassis, the method comprising:
providing an injection mold comprising a cavity corresponding to a near-net shape of a mobile phone chassis;
injecting a MIM composition into the injection mold to form a green mobile phone chassis, wherein the MIM composition comprises titanium and at least one binder;
debinding the green mobile phone chassis to form a brown mobile phone chassis; and
infusing the brown mobile phone chassis with copper to form the mobile phone chassis.
   7. The method of example 6 further comprising forming an antenna break in the mobile phone chassis.
   8. The method of example 6 or example 7, wherein the step of infusing the brown mobile phone chassis with copper comprises sintering the brown mobile phone chassis.
   9. A method of making a mobile phone chassis, the method comprising:
providing an injection mold comprising a cavity corresponding to a near-net shape of a mobile phone chassis;
injecting a MIM composition into the injection mold to form a green mobile phone chassis, wherein the MIM composition comprises titanium, copper, and at least one binder;
debinding the green mobile phone chassis to form a brown mobile phone chassis; and
sintering the brown mobile phone chassis to form the mobile phone chassis.
   10. The method of example 9 further comprising forming an antenna break in the mobile phone chassis.
   11. A mobile phone comprising a mobile phone chassis of any one of examples 1-10.
   12. The mobile phone of example 11, wherein the mobile phone does not include a thermal heat sink component.
   13. The mobile phone of example 11 or example 12, wherein the mobile phone comprises a processor that is not programmed to underclock if the processor exceeds about 70° C.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

1-3. (canceled)

4. The mobile phone of claim 7, further comprising an antenna break.

5. The mobile phone of claim 8, further comprising an antenna break.

6. The mobile phone chassis of claim 7, further comprising an antenna break.

7. A mobile phone comprising:
a mobile phone chassis comprising titanium and copper; and
a processor that is not programmed to underclock if the processor exceeds a temperature threshold,
wherein the mobile phone does not include a thermal heat sink component.

8. A mobile phone comprising:
a mobile phone chassis consisting essentially of titanium and copper; and
a processor that is not programmed to underclock if the processor exceeds a temperature threshold,
wherein the mobile phone does not include a thermal heat sink component.

9. The mobile phone of claim 7, wherein the mobile phone chassis comprises approximately 10% copper or more than 10% copper.

10. The mobile phone of claim 8, wherein the mobile phone chassis comprises approximately 10% copper or more than 10% copper.

11. The mobile phone of claim 7, wherein the mobile phone chassis comprises approximately 10% copper or more than 10% copper.

12. The mobile phone of claim 7, wherein the copper occupies cavities in the mobile phone chassis previously occupied by a binder.

13. The mobile phone of claim 8, wherein the copper occupies cavities in the mobile phone chassis previously occupied by a binder.

14. The mobile phone of claim 7, wherein the copper occupies cavities in the mobile phone chassis previously occupied by a binder.

15-30. (canceled)

31. A mobile phone comprising:
a mobile phone chassis consisting essentially of:
titanium defining a plurality of cavities therein, and
approximately 10% copper or more than 10% copper occupying the plurality of cavities;
a processor that is not programmed to underclock if the processor exceeds a temperature threshold; and
an antenna break,
wherein the mobile phone does not include a thermal heat sink component.
